(19) United States
(12) Patent Application Publication
(10) Pub. No.: US 2013/0118685 A1
(43) Pub. Date: May 16, 2013

(54) Wafer lens member producing method, image pickup lens producing method, image pickup module producing method, and image pickup module-installed electronic device producing method

(71) Applicant: Akiko HARA, Tokyo (JP)

(72) Inventor: Akiko HARA, Tokyo (JP)

(73) Assignee: Konica Minolta Advanced Layers, Inc., Tokyo (JP)

(21) Appl. No.: 13/665,836

(22) Filed: Oct. 31, 2012

(30) Foreign Application Priority Data
Apr. 30, 2010 (JP) 2010-104850

(51) Int. Cl. B29D 11/00

(52) U.S. Cl. CPC B29D 11/0073
USPC 156/309.6; 264/1.36; 29/412; 29/411

(57) ABSTRACT

A wafer lens member producing method includes post-curing lens portions made of a light-curing resin formed on at least one face of a substrate so as to promote curing of the light-curing resin. The post-curing includes first post-curing and second post-curing. The first post-curing performs heating at a first post-curing temperature, which is a glass transition temperature of the light-curing resin to the glass transition temperature+100° C., for 30 minutes to two hours. The second post-curing performs heating at a second post-curing temperature, which is lower than the glass transition temperature, and lower than the first post-curing temperature by 25° C. or more, for three hours to six hours.

### CROSS REFERENCE TO RELATED APPLICATION

This application is a continuation-in-part (CIP) of International Application No. PCT/JP2011/059916 filed Apr. 22, 2011 which claims priority to Japanese Patent Application No. 2010-104850 filed Apr. 30, 2010. The disclosure of each of the prior applications is hereby incorporated by reference in its entirety.

### BACKGROUND OF THE INVENTION

1. Field of the Invention

The present invention relates to a wafer lens member producing method, an image pickup lens producing method, an image pickup module producing method, and an image pickup module-installed electronic device producing method.

2. Description of the Related Art

Conventionally, image pickup devices, so-called image pickup modules, are installed in portable terminals which are compact slim electronic devices such as mobile phones and PDA (Personal Digital Assistant), whereby the portable terminals can transmit not only audio information but also image information to each other over a long distance. As image pickup elements used in these image pickup modules, solid-state image sensors such as CMOS (Complementary Metal Oxide Semiconductor) image sensors are used. As image pickup lenses used in the image pickup modules, resin lenses are used. The resin lenses can be mass-produced at low cost, and easily have aspheric surfaces. Hence, the resin lenses are used in the image pickup modules for cost reduction and miniaturization. An image pickup module is constituted of such an image pickup element and such an image pickup lens combined.

For a current portable terminal (electronic device), as a method for mounting an image pickup module, in which an image pickup lens is installed, on a printed circuit board of an electronic device, reflow soldering (“reflow” hereinafter) is adopted. During reflow, solder is disposed in advance at points on a printed circuit board, the points where electronic components including the image pickup module are disposed; the electronic components are disposed thereon; heating is performed so that the solder is melt; and then cooling is performed, whereby the electronic components are mounted on the printed circuit board, which is disclosed by, for example, Japanese Patent Application Laid-Open Publication No. 2009-98506. The electronic components are automatically mounted (fixed) on the printed circuit board in a reflow oven. By adopting such reflow, cost for mounting electronic components on a printed circuit board can be low, and quality of conformance can be maintained at a certain level. Then, there are needs for image pickup lenses having excellent heat resistance to sustain reflow.

As a method for producing an image pickup lens which can be mass-produced, is a small size, and has high heat resistance, there is a replica method. In the replica method, a large number of lens portions made of curing resins having high heat resistance are simultaneously formed on a glass substrate having a thickness of several inches, the glass substrate being a parallel plate. A method for mass-producing image pickup modules by using the replica method to simultaneously form a large number of lens elements (lens portions) on a glass substrate has been proposed. In the method, the glass substrate on which a large number of lens elements are formed, namely, a wafer lens, is combined with a sensor wafer, and then the wafer lens combined with the sensor wafer is cut into pieces, whereby image pickup modules are mass-produced.

Then, as a method for producing an electronic device, such as a portable terminal, having an image pickup module suitable for mass production installed, the method with which producing cost can be low, and quality of conformance can be maintained at a certain level, it is considered to perform reflow soldering so as to mount an image pickup module produced by using the replica method on a printed circuit board of an electronic device, whereby an electronic device is produced.

An example of the image pickup lens having excellent heat resistance to sustain reflow is a glass lens. However, in order to adopt the above replica method, it is necessary to mold lens portions out of resin. As high heat resistant resins, use of the curing resins is considered. The high heat resistant curing resins can be roughly classified into light curing resins and thermosetting resins (heat curing resins). Examples of the light curing resins are acrylic resins, allyl resins, and epoxy resins. Acrylic resins and allyl resins can be cured by radical polymerization. Epoxy resins can be cured by cationic polymerization. On the other hand, examples of the thermosetting resins include resins which can be cured by radical polymerization, cationic polymerization, or addition polymerization which cures silicon. If, of the curing resins, thermosetting resins are used, it is necessary to make a temperature of a mold high to cure the resins. In particular, to evenly heat a plurality of lenses (lens portions/elements) which are formed to be united by using the replica method, it is necessary that an apparatus which performs heating is large to control the temperature and to heat the mold. Hence, it is preferable to use the light curing resins.

However, if the light curing resins are used, a different problem arises. In order to cure the light curing resins, the resin materials are irradiated with UV light for cure via a mold. Hence, it is difficult to completely cure the light curing resins within a short period of time. In particular, although epoxy resins have excellent transfer accuracy of lens shapes and the like because epoxy resins, which are cured by cationic polymerization, is lower in curing shrinkage than acrylic resins, which are cured by radical polymerization, cationic polymerization is slower reaction than radical polymerization, and its reaction rate obtained only by UV irradiation is not 100% but about 60%. If resin is not completely cured, the optical properties change after the resin is taken out from a mold as a surface shape and/or a refractive index changes in accordance with progress of the resin cure. Consequently, a problem arises that an image pickup lens has optical design values different from its original optical design values. In particular, in the case where an image pickup module is mounted on a printed circuit board by reflow, the image pickup module (image pickup lens) is exposed to high temperature environment, so that resin cure suddenly progresses. Consequently, the image pickup module (image pickup lens) has optical design values greatly different from its original optical design values. In addition, when reflow is performed, because positions of an image pickup element such as a CMOS image sensor and an optical element (i.e. a distance therebetween) are fixed, even if some change occurs to the optical element, it is difficult to correct the positions and the like so as to correct the change. Hence, the problem is large. However, in order to completely cure the light-curing resins in a mold, a molding time becomes long, whereby producing cost increases.

In order to solve a similar problem, for example, Japanese Patent Application Laid-Open Publication No. 2009-98506 and Japanese Patent Application Laid-Open Publication No. 2009-100350 propose technologies to mold an optical element (lens) out of a thermosetting resin, take out the resin from a die before being completely cured, and perform optical design by deducting in advance an expected amount which the refractive power of the lens changes when the resin is completely cured after being taken out from the die. In these technologies, proposals are made to perform optical design by taking change which occurs when the thermosetting resin is cured by reflow into account, and to appropriately adjust the optical properties of an image pickup module by utilizing change of the refractive power of an optical element, the change which occurs by reflow. In addition, a proposal is made to perform post-curing at 100° C. or more for one hour or more to cure the thermosetting resin to some extent before reflow. Hereinafter, “post-curing” is heating an optical element made of the curing resins after the optical element is taken out from a mold in order to promote the cure of the curing resins.

### SUMMARY OF THE INVENTION

A circuit board goes through a reflow oven so that reflow is performed. Reflow is performed one time or multiple times, depending on a degree of solder adhesion. Further, conditions for reflow are somewhat different between electronic device producers. Therefore, it is sometimes difficult to design an optical element by taking change in the optical properties of the optical element during reflow into account. Also, it is sometimes difficult to adjust the optical properties of a camera module (image pickup module) by utilizing change in the optical properties during reflow.

The change during reflow may be reduced by performing post-curing at a high temperature for a long time to almost completely cure the curing resins. Although the change caused by reflow is reduced by performing post-curing at a high temperature for a long time, another problem arises. That is, the curing resins turn yellow, and the transmittance decreases. The curing resins do not turn yellow by performing post-curing at a low temperature for a long time, but the change in the optical properties during reflow cannot be reduced enough thereby. Furthermore, another problem arises depending on conditions for post-curing. That is, in the case where lens portions are molded out of resin to be formed on a glass substrate, and a wafer lens having the lens portions on the glass substrate is cut (diced) before reflow, the resin could be separated from the glass substrate by internal stress of the lens portions.

The present invention is made in view of the above-described circumstances. Objects of the present invention include providing a wafer lens member producing method, an image pickup lens producing method, and an image pickup module producing method which can prevent the surface shape and the refractive index from changing, prevent the light transmittance from decreasing, and prevent resin from separating from a glass substrate, no matter how many times reflow is performed. The objects thereof also include providing an electronic device producing method, the electronic device using the obtained image pickup module.

According to a first aspect of the present invention, there is provided a wafer lens member producing method for producing a wafer lens member with a plurality of lens portions made of a light-curing resin formed on at least one face of a substrate, the method including: curing the light-curing resin filled between a mold having a molding face which forms the lens portions and the at least one face of the substrate; releasing the mold from the substrate; and post-curing the lens portions so as to promote the curing of the light-curing resin, the post-curing including: first post-curing which performs heating at a first post-curing temperature, which is a glass transition temperature of the light-curing resin to the glass transition temperature+100° C., for 30 minutes to two hours; and second post-curing which performs heating at a second post-curing temperature, which is lower than the glass transition temperature, and lower than the first post-curing temperature by 25° C. or more, for three hours to six hours.

According to a second aspect of the present invention, there is provided an image pickup lens producing method including: dicing the wafer lens member produced by the wafer lens member producing method into pieces which respectively include the lens portions.

According to a third aspect of the present invention, there is provided an image pickup module producing method including: superposing the wafer lens member produced by the wafer lens member producing method on an image pickup element member on which a plurality of image pickup element portions is formed; and dicing the wafer lens member superposed on the image pickup element member into pieces which respectively include the lens portions, and which respectively include the image pickup element portions.

According to a fourth aspect of the present invention, there is provided an electronic device producing method including: performing reflow so as to mount the image pickup module produced by the image pickup module producing method on a circuit board.

### BRIEF DESCRIPTION OF THE DRAWINGS

The present invention will be fully understood by the following detailed description and the accompanying drawings, which are not intended to limit the present invention, wherein:

FIG. 1 is a cross-sectional view schematically showing configurations of an image pickup module and an image pickup lens used in the image pickup module; and

FIG. 2 is a cross-sectional view for schematically explaining a state in which a wafer lens laminated body, which is produced in a process of producing the image pickup lens, is cut.

### DETAILED DESCRIPTION OF THE PREFERRED EMBODIMENTS

In the following, an embodiment of the present invention is described, referring to the drawings.

### [Image Pickup Module]

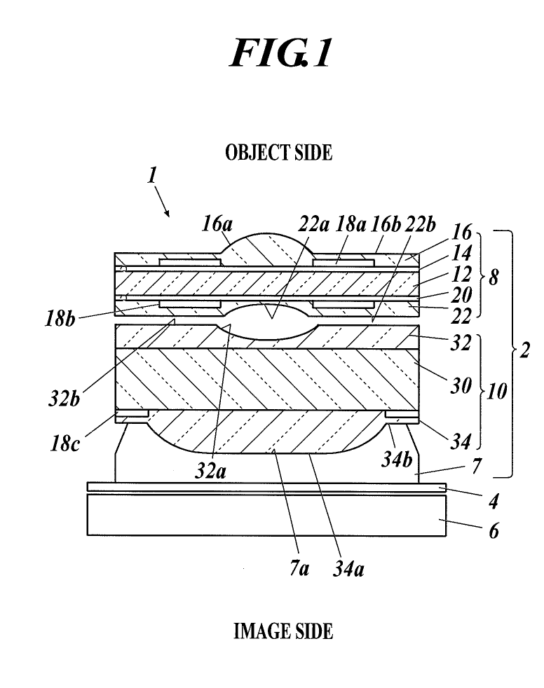

As shown in FIG. 1, an image pickup module 1 includes an image pickup lens 2, an optical low-pass filter 4, and an image pickup element 6. The optical low-pass filter 4 and the image pickup element 6 are disposed under the image pickup lens 2. As the image pickup element 6, a CMOS image sensor is used, for example.

The image pickup lens 2 is constituted of two lens groups 8 and 10, and a spacer 7.

The lens group 8 includes a glass substrate 12.

A resin portion 16 is formed on the upper face of the glass substrate 12. An IR cut-off filter 14 and an aperture stop 18a are formed between the glass substrate 12 and the resin portion 16. The resin portion 16 is constituted of a convex lens portion 16a and a no-lens portion 16b around the convex lens portion 16a. The convex lens portion 16a and the no-lens portion 16b are formed to be united. The surface of the convex lens portion 16a is aspheric. The aperture stop 18a is covered with the no-lens portion 16b.

A resin portion 22 is formed on the lower face of the glass substrate 12. An IR cut-off filter 20 and an aperture stop 18b are formed between the glass substrate 12 and the resin portion 22. The resin portion 22 is constituted of a concave lens portion 22a and a no-lens portion 22b around the concave lens portion 22a. The concave lens portion 22a and the no-lens portion 22b are formed to be united. The surface of the concave lens portion 22a is aspheric. The aperture stop 18b is covered with the no-lens portion 22b.

The lens group 8 is constituted of the glass substrate 12, the IR cut-off filters 14 and 20, the resin portions 16 and 22, and the aperture stops 18a and 18b.

The lens group 10 includes a glass substrate 30.

A resin portion 32 is formed on the upper face of the glass substrate 30. The resin portion 32 is constituted of a concave lens portion 32a and a no-lens portion 32b around the concave lens portion 32a. The concave lens portion 32a and the no-lens portion 32b are formed to be united. The surface of the concave lens portion 32a is aspheric. A resin portion 34 is formed on the lower face of the glass substrate 30. An aperture stop 18c is formed between the glass substrate 30 and the resin portion 34. The resin portion 34 is constituted of a convex lens portion 34a and a no-lens portion 34b around the convex lens portion 34a. The convex lens portion 34a and the no-lens portion 34b are formed to be united. The surface of the convex lens portion 34a is aspheric. The aperture stop 18c is covered with the no-lens portion 34b.

The lens group 10 is constituted of the glass substrate 30, the resin portions 32 and 34, and the aperture stop 18c.

The resin portions 16 and 22 of the lens group 8 and the resin portions 32 and 34 of the lens group 10 are made of publically-known light curing resins.

As the light curing resins, for example, the following acrylic resins, allyl ester resins, or epoxy resins can be used. In particular, epoxy resins which are slow in reaction are effective in the present invention in terms of their excellent transfer accuracy of the surface shape (shapes of the surfaces of the lens portions 16a, 22a, 32a and 34a).

Acrylic resins and allyl ester resins can be cured by radical polymerization. Epoxy resins can be cured by cationic polymerization.

Resin making the resin portions 16 and 22 of the lens group 8 and the resin portions 32 and 34 of the lens group 10 may be the same kind or different kinds of resin.

The resin is described in the following (1) to (3), to be more specific.

### (1) Acrylic Resin

(Meth)acrylate used for polymerization reaction is not specifically limited, and the following (meth)acrylate prepared by conventional preparation methods can be used. Examples of (meth)acrylate include ester (meth)acrylate, urethane (meth)acrylate, epoxy (meth)acrylate, ether (meth)acrylate, alkyl(meth)acrylate, alkylene(meth)acrylate, (meth)acrylate having an aromatic ring, (meth)acrylate having an alicyclic structure, and the like. These are used solely, or in combination with two kinds or more thereof.

In particular, (meth)acrylate having an alicyclic structure is preferable, and the alicyclic structure may contain an oxygen atom or a nitrogen atom. Examples thereof include cyclohexyl(meth)acrylate, cyclopentyl(meth)acrylate, cycloheptyl(meth)acrylate, bicycloheptyl(meth)acrylate, tricyclodecyl(meth)acrylate, tricyclodecane dimethanol(meth)acrylate, isobornyl(meth)acrylate, dimethacrylate classified as hydrogenated bisphenol, and the like. Further, (meth)acrylate with an alicyclic structure having an adamantane skeleton is preferable, in particular. Examples thereof include 2-alkyl-2-adamantyl(meth)acrylate (refer to Japanese Patent Application Laid-Open Publication No. 2002-193883), adamantyl di(meth)acrylate (refer to Japanese Patent Application Laid-Open Publication No. 57-500785), adamantyl dicarboxylic acid diallyl (refer to Japanese Patent Application Laid-Open Publication No. 60-100537), perfluoroadamantyl acrylic acid ester (refer to Japanese Patent Application Laid-Open Publication No. 2004-123687), 2-methyl-2-adamantyl methacrylate produced by Shin-Nakamura Chemical Co., Ltd., 1,3-adamantane diol diacrylate, 1,3,5-adamantane triol triacrylate, unsaturated carboxylic acid adamantyl ester (refer to Japanese Patent Application Laid-Open Publication No. 2000-119220), 3,3′-dialkoxycarbonyl-1,1′biadamantane (refer to Japanese Patent Application Laid-Open Publication No. 2001-253835), 1,1′-biadamantane compound (refer to U.S. Pat. No. 3,342,880), tetra adamantane (refer to Japanese Patent Application Laid-Open Publication No. 2006-169177), 2-alkyl-2-hydroxy adamantane, 2-alkylene adamantane, a curing resin having an adamantane skeleton not including an aromatic ring such as 1,3-adamantane di-tert-butyl dicarboxylate (refer to Japanese Patent Application Laid-Open Publication No. 2001-322950), bis(hydroxyphenyl)adamantanes, bis(glycidyl oxyphenyl)adamantane (refer to Japanese Patent Application Laid-Open Publication No. 11-35522 and Japanese Patent Application Laid-Open Publication No. 10-130371), and the like.

Further, reactive monomers may be contained. Examples of (meth)acrylate include methyl acrylate, methyl methacrylate, n-butyl acrylate, n-butyl methacrylate, 2-ethyl hexyl acrylate, 2-ethyl hexyl methacrylate, isobutyl acrylate, isobutyl methacrylate, tert-butyl acrylate, tert-butyl methacrylate, phenyl acrylate, phenyl methacrylate, benzyl acrylate, benzyl methacrylate, cyclohexyl acrylate, cyclohexyl methacrylate, and the like.

As polyfunctional (meth)acrylate, the followings are included as examples: trimethylolpropane tri(meth)acrylate, pentaerythritol tetra(meth)acrylate, pentaerythritol tri(meth)acrylate, dipentaerythritol hexa(meth)acrylate, dipentaerythritol penta(meth)acrylate, dipentaerythritol tetra(meth)acrylate, dipentaerythritol tri(meth)acrylate, tripentaerythritol octa(meth)acrylate, tripentaerythritol hepta(meth)acrylate, tripentaerythritol hexa(meth)acrylate, tripentaerythritol penta(meth)acrylate, tripentaerythritol tetra(meth)acrylate, tripentaerythritol tri(meth)acrylate, and the like.

### (2) Allyl Ester Resin

Allyl ester resins are resins each having an allyl group and cured by radical polymerization. Although not specifically being limited thereto, examples thereof include the followings.

The examples thereof include bromine-containing (meth)allyl ester not including an aromatic ring (refer to Japanese Patent Application Laid-Open Publication No. 2003-66201), allyl(meth)acrylate (refer to Japanese Patent Application Laid-Open Publication No. 5-286896), an allyl ester resin (refer to Japanese Patent Application Laid-Open Publication No. 5-286896 and Japanese Patent Application Laid-Open Publication No. 2003-66201), a copolymeric compound of acrylic acid ester and an epoxy group-containing unsaturated compound (refer to Japanese Patent Application Laid-Open Publication No. 2003-128725), an acrylate compound (refer to Japanese Patent Application Laid-Open Publication No. 2003-147072), an acrylic ester compound (refer to Japanese Patent Application Laid-Open Publication No. 2005-2064), and the like.

### (3) Epoxy Resin

Epoxy resins are not specifically limited as long as they each have an epoxy group, and are cured with light or heat. Furthermore, for epoxy resins, acid anhydride, a cation generating agent or the like can be used as a curing initiator. Epoxy resins are preferable because they have low cure shrinkage, and accordingly lenses can be produced at excellent molding accuracy.

Examples of epoxy resins include a novolak phenol type epoxy resin, a biphenyl type epoxy resin and a dicyclopentadiene type epoxy resin. More specifically, examples of epoxy resins include bisphenol F diglycidyl ether, bisphenol A diglycidyl ether, 2,2′-bis(4-glycidyl oxycyclohexyl)propane, 3,4-epoxycyclohexyl methyl-3,4-epoxycyclohexane carboxylate, vinylcyclohexene dioxide, 2-(3,4-epoxycyclohexyl)-5,5-spiro(3,4-epoxycyclohexane)-1,3-dioxane, bis(3,4-epoxycyclohexyl)adipate, 1,2-cyclopropane dicarboxylic acid bisglycidyl ester, and the like.

A curing agent is used to constitute curing resin material, and not specifically limited. In the embodiment, when comparison is made in transmittance between the curing resin material and optical material to which an addition agent has been added, the curing agent is not included in the addition agent. As the curing agent, an acid anhydride curing agent, a phenol curing agent, and the like are preferably used. Examples of the acid anhydride curing agent include phthalic anhydride, maleic anhydride, trimellitic anhydride, pyromellitic anhydride, hexahydrophthalic anhydride, 3-methyl-hexahydrophthalic anhydride, 4-methyl-hexahydrophthalic anhydride, a mixture of 3-methyl-hexahydrophthalic anhydride and 4-methyl-hexahydrophthalic anhydride, tetrahydrophthalic anhydride, nadic anhydride, methylnadic anhydride, and the like. In addition, a curing accelerator is contained as needed. The curing accelerator is not specifically limited, as long as the curing accelerator has excellent curability (hardenability), is not colored, and does not spoil transparency of thermosetting resins. Examples of the curing accelerator include imidazoles such as 2-ethyl-4-methylimidazole (2E4MZ), tertiary amine, quarternary ammonium salt, bicyclic amidines such as diazabicycloundecen and derivatives thereof, phosphine, phosphonium salt, and the like. These are used solely or in combination with two kinds or more thereof.

In the image pickup lens 2, an adhesive is applied to between the no-lens portion 22b of the lens group 8 and the no-lens portion 32b of the lens group 10, so that the lens group 8 and the lens group 10 adhere to each other. In FIG. 1, the lens group 8 and the lens group 10 are separated from each other. However, the lens group 8 and the lens group 10 may adhere to each other directly with an adhesive. Alternatively, a not-shown spacer member may be provided between the no-lens portion 22b and the no-lens portion 32b, and the lens group 8 and the lens group 10 may join via the spacer member with an adhesive. The no-lens portions 22b and 32b are flange portions of the concave lens portions 22a and 32a, respectively.

The spacer 7 adheres to the lens group 10 in such a way as to abut the no-lens portion 34b. The lens group 10 adheres to the upper face of the optical low-pass filter 4 via the spacer 7. An opening portion 7a is formed in the spacer 7. The convex lens portion 34a is disposed in the opening portion 7a.

In the image pickup lens 2, the convex lens portion 16a, the concave lens portion 22a, the concave lens portion 32a, the convex lens portion 34a, and the opening portion 7a of the spacer 7 has aspheric surfaces, and their optical axes are matched.

In the image pickup lens 2, the convex lens portion 16a of the lens group 8 is disposed on an object side, and the convex lens portion 34a of the lens group 10 is disposed on an image side.

The convex lens portion 16a, the concave lens portion 22a, the concave lens portion 32a, and the convex lens portion 34a constitute an optical surface of the lens group 8 on the object side, the “first surface S1”, an optical surface of the lens group 8 on the image side, the “second surface S2”, an optical surface of the lens group 10 on the object side, the “third surface S3”, and an optical surface of the lens group 10 on the image side, the “fourth surface S4”, respectively.

### [Image Pickup Module (Image Pickup Lens) Producing Method]

Next, a method for producing the image pickup module 1 (including a method for producing the image pickup lens 2) is described in summary.

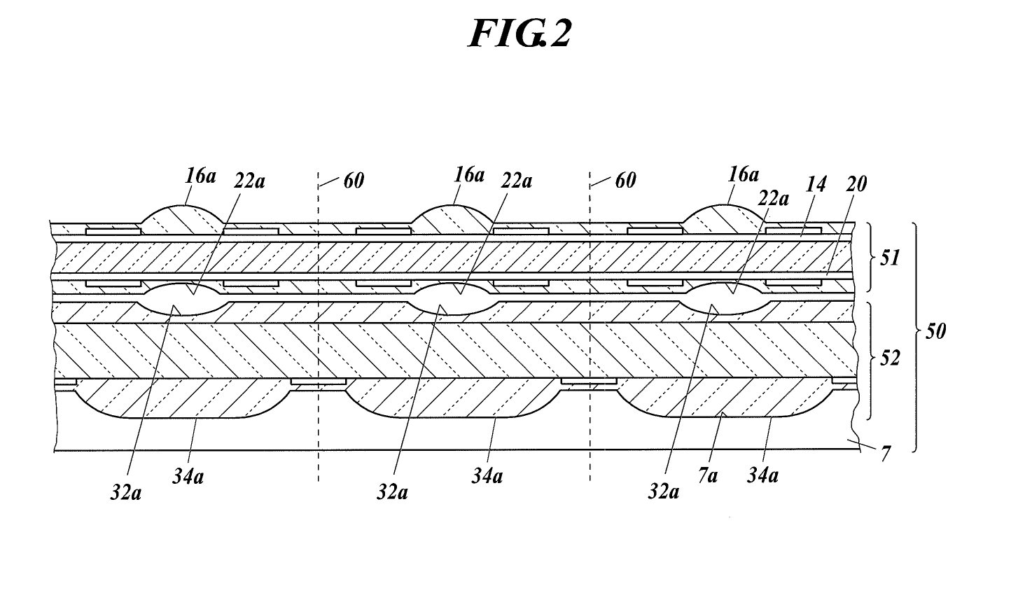

First, the IR cut-off filters 14 and 20 are formed on the glass substrate 12 as needed. As shown in FIG. 2, in the embodiment, the IR cut-off filters 14 and 20 are respectively disposed on the both faces (the upper face and the lower face) of the glass substrate 12 so that a first wafer lens 51 is prevented from warping. However, an IR cut-off filter may be disposed only one face of the glass substrate 12. If an IR cut-off filter is disposed on the upper face of an image pickup element (image pickup element 6), it is unnecessary to provide a wafer lens with an IR cut-off filter. The IR cut-off filters 14 and 20 are formed on the both faces of the glass substrate 12 by using publically-known vacuum deposition, sputtering, CVC (Chemical Vapor Deposition) or the like. An IR cut-off filter (infrared ray shielding film) is a film to prevent unnecessary infrared rays from being incident on an image pickup element. However, if an IR cut-off filter is disposed on a wafer lens, it is preferable that the IR cut-off filter have the transmittance of 50% or more to light having a wavelength of 365 nm, the light which is used to cure an adhesive with which an image pickup element and the wafer lens (or image pickup lens) adhere to each other. By having the configuration, a wafer lens (or image pickup lens) and an image pickup element are not inhibited from adhering to each other by an IR cut-off filter.

Next, a light-blocking photoresist or the like is applied to the glass substrate 12, and patterned to be in a predetermined shape so as to form a plurality of aperture stops 18a. The light-blocking photoresist is not specifically limited. Examples thereof include a photoresist made of resin mixed with carbon black and a photoresist made of metal.

After that, a light-curing resin is dropped into a mold, one of the mold and the wafer glass substrate 12 is pressed against the other thereof so that the light-curing resin is filled between the mold and the glass substrate 12, and the mold and the glass substrate 12 having the light-curing resin in between is irradiated with light so that the light-curing resin is cured (curing). Consequently, a plurality of convex lens portions 16a is formed on the glass substrate 12. In the case where the light-curing resin is an epoxy resin, even when the light-curing resin is irradiated with light, the light-curing resin does not completely react to the light (i.e. not completely cure). Hence, when the mold is released from the glass substrate 12, the glass substrate 12 hardly warps.

After that, the glass substrate 12 is turned over, and a plurality of aperture stops 18b and a plurality of concave lens portions 22a are formed on the glass substrate 12 in the same manner as that described above (curing).

After the lens portions 16a and 22a are formed, the molds are released from the glass substrate 12 (releasing). The molds may be released from the glass substrate 12 respectively after the convex lens portions 16a are formed and after the concave lens portions 22a are formed. Alternatively, the molds may be released from the glass substrate 12 together after the convex lens portions 16a and the concave lens portions 22a are formed.

After releasing, post-curing is performed on the lens portions 16a and 22a respectively formed on the both faces (the upper face and the lower face) of the glass substrate 12 so that heating is performed thereon (post-curing). Post-curing may be performed on the lens portions 16a and 22a together in a constant temperature oven, or may be performed on the lens portions 16a and on the lens portions 22a separately after the lens portions 16a or 22a are formed on the glass substrate 12 and the mold is released from the glass substrate 12. It is preferable to perform post-curing after both the convex lens portions 16a and the concave lens portions 22a are formed on the glass substrate 12 and the molds are released from the glass substrate 12 in terms of prevention of warps of the wafer lens 51 and efficiency. Thus, the wafer lens 51 (shown in FIG. 2) having the convex lens portions 16a and the concave lens portions 22a is produced.

More specifically, in post-curing, after post-curing (first post-curing) is performed at a temperature (first post-curing temperature), which is a glass transition temperature Tg of the light-curing resin to the Tg+100° C., for 0.5 to 2 hours (first post-curing processing time), another post-curing (second post-curing) is performed at a temperature (second post-curing temperature), which is lower than the Tg, and also lower than the first post-curing temperature by 25° C. or more, for 3 to 6 hours (second post-curing processing time). After that, another post-curing (third post-curing) may be performed at a temperature (third post-curing temperature), which is the Tg to the Tg+100° C., for 0.25 (15 minutes) to 1 hour (third post-curing processing time). In the present invention, a glass transition temperature Tg is a value obtained as follows; both faces of a sample having a diameter of 10 mm and a thickness of 1 mm are irradiated with UV light of 6000 mJ/cm²; post-curing is performed on the sample so as to sufficiently cure and bridge the sample; and then the sample is measured by a TMA (Thermo-Mechanical Analysis) device at a rate of temperature increase of 10° C./min.

The first post-curing temperature is preferably a Tg of the light-curing resin+10° C. to the Tg+90° C., and more preferably the Tg+10° C. to the Tg+50° C. The first post-curing processing time is preferably 0.75 (45 minutes) to 1.5 hours, more preferably 50 minutes to 1 hour and 10 minutes, and most preferably 1-hour (1 hour±5 minutes).

The second post-curing temperature is preferably 80° C. to a temperature which is lower than the Tg, and lower than the first post-curing temperature by 25° C. or more, and more preferably 100° C. to the temperature which is lower than the Tg, and lower than the first post-curing temperature by 25° C. or more. The second post-curing processing time is preferably 4 to 6 hours. The third post-curing temperature is preferably the Tg+10° C. to the Tg+90° C., and more preferably the Tg+10° C. to the Tg+50° C. The third post-curing processing time is preferably 0.5 (30 minutes) to 1 hour, and more preferably 0.5 (30 minutes) to 0.75 hours (45 minutes).

In the above post-curing, after first post-curing is performed, second post-curing is performed. However, the order thereof may be reversed, so that it is possible that after second post-curing is performed, first post-curing is performed. If second post-curing, the post-curing temperature (second post-curing temperature) of which is relatively low, is performed before first post-curing, the curing resin is gradually cured. Hence, in terms of the stability of the surface shape in post-curing, it is preferable to perform second post-curing before first post-curing.

Furthermore, third post-curing and/or fourth post-curing may be performed after first post-curing and second post-curing, as needed. It is preferable to perform third post-curing after first post-curing and second post-curing. By performing third post-curing after first post-curing and second post-curing, distortion which is caused or remains for some reasons can be removed or reduced, so that the stability of the surface shape increases more.

Furthermore, first post-curing and second post-curing may be performed continuously. Alternatively, first post-curing and second post-curing may be performed non-continuously by performing one of first post-curing and second post-curing, taking out the wafer lens 51 from a constant temperature oven once, and performing the other thereof thereafter. As a method for continuously performing first post-curing and second post-curing, for example, the wafer lens 51 is placed in a constant temperature oven, the temperature of which is set to correspond to the first post-curing temperature; after a necessary time elapses, the temperature of the constant temperature oven is made to decrease to correspond to the second post-curing temperature; and the decreased temperature is maintained for a necessary time. The same (similar) manner applies to the case where second post-curing is performed before first post-curing. As a method for non-continuously performing first post-curing and second post-curing, for example, a constant temperature oven, the temperature of which is set to correspond to the first post-curing temperature, and another constant temperature oven, the temperature of which is set to correspond to the second post-curing temperature, are prepared; the wafer lens 51 is placed in one of the constant temperature ovens; and after a necessary time elapses, the wafer lens 51 is taken out from the constant temperature oven, and placed and maintained in the other thereof for a necessary time.

In the present application, a temperature in post-curing indicates a surface temperature of a wafer lens on which post-curing is being performed. The surface temperature of a wafer lens can be measured by a thermocouple.

After that, in the same manner as that for producing the wafer lens 51, a plurality of aperture stops 18c, a plurality of concave lens portions 32a, and a plurality of convex lens portion 34a are formed on the glass substrate 30, and the molds are released from the glass substrate 30, so that a wafer lens is produced. After releasing, the above-described post-curing (first post-curing and second post-curing) is performed. Note that it is unnecessary to provide the glass substrate 30 with an IR cut-off filter.

It is preferable to form an antireflection film (not shown) on the resin portion 34 as needed. As a structure of the antireflection film, a publically-known structure can be used. In the structure, a plurality of layers having different refractive indexes are superposed on top of each other, the plurality of layers being at least two layers, one layer having a high refractive index and the other layer having a low refractive index (two-layer structure). In the case of the two-layer structure, a first layer is directly formed on the resin portion 34, and a second layer is formed on the first layer.

In this case, the first layer is a layer made of material having a refractive index of 1.7 or more. Preferably, the first layer is made of Ta₂O₅, a mixture of Ta₂O₅ and TiO₂, ZrO₂, or a mixture of ZrO₂ and TiO₂. The first layer may be made of TiO₂, Nb₂O₃, or HfO₂.

The second layer is a layer made of material having a refractive index of less than 1.7. Preferably, the second layer is made of SiO₂.

Both the first layer and the second layer of the antireflection film are formed by deposition or the like. Preferably, the first layer and the second layer are formed with their forming temperature maintained within a range of a melting temperature of a conductive paste such as solder used for reflow±40° C. (±20° C., preferred).

The antireflection film may have a three- to seven-layer structure, in which a first layer (s) and a second layer (s) are superposed alternately. In this case, a layer directly contacting the resin portion 34 may be a layer made of material having a high refractive index (first layer) or a layer made of material having a low refractive index (second layer) in accordance with the kind of resin of the resin portion 34. In the embodiment, the layer directly contacting the resin portion 34 is a layer made of material having a high refractive index (first layer).

In the embodiment, the antireflection film is formed only on the surface of the resin portion 34. However, the antireflection film may be formed on the surface of each of the resin portions 16, 22, 32, and 34.

It is effective to provide the surface of the resin portion 34 with the antireflection film to prevent ghosts from being produced on the image pickup element 6, and it is preferable to provide only the resin portion 34 with the antireflection film to prevent cracks, which are produced at the interface between an antireflection film and a resin portion.

The antireflection film may be formed (antireflection film forming is performed) after or before post-curing. Alternatively, the antireflection film may be formed between first post-curing and second post-curing. Antireflection film forming and first post-curing or second post-curing may be performed together by making a temperature and a processing time for antireflection film forming the same as the post-curing time and the processing time for first post-curing or second post-curing. In order to prevent the antireflection film from being deformed by change in the surface shape or the like, it is preferable to form the antireflection film after second post-curing at least.

Thus, the wafer lens 52 (shown in FIG. 2) having the concave lens portions 32a and the convex lens portions 34a is produced.

After that, an adhesive is applied to at least one of the no-lens portions 22b and the no-lens portions 32b so that the wafer lenses 51 and 52 adhere to each other (shown in FIG. 2). In FIG. 2, the no-lens portions 22b and the no-lens portions 32b are separated from each other. However, the no-lens portions 22b and the no-lens portions 32b may directly adhere to each other with an adhesive or via a not-shown spacer disposed therebetween with an adhesive.

In addition, an adhesive is applied to at least one of the spacer 7 and the no-lens portions 34b of the wafer lens 52 so that the spacer 7 and the wafer lens 52 adhere to each other.

Consequently, a wafer lens laminated body 50 (shown in FIG. 2) is produced.

After that, the wafer lens laminated body 50 is cut (diced) at dicing lines 60 by using a dicer (dicing machine) or the like into pieces, each of which includes a convex lens portion 16a, a concave lens portion 22a, a concave lens portion 32a and a convex lens portion 34a, as shown in FIG. 2 (dicing).

Consequently, a plurality of image pickup lenses 2 is produced.

In the embodiment, the wafer lenses 51 and 52 are superposed on top of each other so that the wafer lens laminated body 50 is produced, and then the wafer lens laminated body 50 is cut so that the image pickup lenses 2 are produced. However, if an image pickup lens is constituted of one lens group, a plurality of image pickup lenses is obtained by cutting a wafer lens without superposing wafer lenses on top of each other.

When the resin portions 16, 22, 32 and 34 of the wafer lens laminated body 50 are diced, it is preferable to use a dicer which performs cutting using an endless cutter (rotary cutter) with abrasive grains, and to make the rotation speed 3 to 7 mm/sec.

When the resin portions 16, 22, 32 and 34 of the wafer lens laminated body 50 are diced, it is preferable to dice them from the object side of the resin portion 16 to the image side of the resin portion 34. During dicing, dust rises at dicing points of the resin portions 16, 22, 32 and 34. Hence, it is preferable to perform dicing while spraying the dicing points with pure water for dust prevention (i.e. squirting pure water for dust prevention at the dicing points).

After that, the image pickup lens 2 is installed in (adheres to) a casing (not shown), and also the optical low-pass filter 4 and the image pickup element 6 are set, so that the image pickup module 1 is produced.

In the embodiment, after the image pickup lens 2 is produced by dicing, the optical low-pass filter 4 and the image pickup element 6 are set, so that the image pickup module 1 is produced. However, image pickup modules 1 can be obtained by superposing the wafer lens laminated body 50 on a substrate on which a plurality of image pickup elements 6 is disposed, and dicing the wafer lens laminated body 50 with the substrate into pieces.

As a method for producing an electronic device, in the case where the image pickup module 1 and other electronic components are mounted on a printed circuit board, solder is disposed on the printed circuit board in advance, the image pickup module 1 and other electronic components are disposed thereon, and the printed circuit board having the image pickup module 1 and other electronic components is (i) placed into and heated by an IR reflow oven so that the solder is melt, and then (ii) cooled, whereby the image pickup module 1 and other electronic components are mounted on the printed circuit board simultaneously.

### Example

In this example, the following alphanumerical references are used.
f Focal distance of the total system of the image pickup lens
fB Back focus
F F-number
2Y Length of a diagonal line of an image pickup plane of the solid-state image sensor
ENTP Entrance pupil position (Distance from the first surface to the entrance pupil position)
EXTP Exit pupil position (Distance from the image pickup plane to the exit pupil position)
H1 Front principal point position (Distance from the first surface to the front principal point position)
H2 Rear principal point position (Distance from the end surface to the rear principal point position)
R Radius of Curvature
D Distance (Interval) between surfaces on an axis
Nd Refractive index of lens material to d line
vd Abbe number of the lens material

In the example, the shape of an aspheric surface is expressed by the following “Equation 1” where C denotes an apex curvature, K denotes a conic constant, and A4, A6, A8, A10, A12, A14 and A16 denote aspheric surface coefficients in the Cartesian coordinate system with the apex of the surface as an origin and the optical axis direction as the X-axis.

$$X = \frac{{Ch}^{2}}{1 + \sqrt{1 - ( 1 + K ) {C}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16} \\ where h = \sqrt{{Y}^{2} + {Z}^{2}} \qquad EQUATION 1$$

### (1) Sample Configuration

### <Samples 1 to 20>

Basically, as each sample, the following image pickup lens having the same configuration as that shown in FIG. 1 is produced.

The image pickup lens is expected to be used for an image pickup element which is ⅕ inches, has a pixel pitch of 1.75 μm, and has 1600×1200 pixels.

As resin making each resin portion, an epoxy resin (a hydrogenated bisphenol A epoxy resin to which 4 wt % of UVI-6992 (produced by the Dow Chemical Company) is added as a UV curing initiator, to be more specific) was used.

Table 1 shows lens data of the image pickup lens. In Table 1, powers of 10 are expressed by using “E” (for example, 2.5×10⁻³ is expressed as 2.5×E-3).

TABLE 1
f = 2.67 mm fB = 0.052 mm F = 2.9 2Y = 3.5 mm
ENTP = 0.24 mm EXTP = −1.76 mm H1 = −1.03 mm H2 = −2.62 mm

| SURFACE | | | | | EFFECTIVE |
|---|---|---|---|---|---|
| NUMBER | R (mm) | D (mm) | Nd | νd | RADIUS (mm) |
| 1* | 0.766 | 0.313 | 1.5139 | 57 | 0.51 |
| 2 (STOP) | ∞ | 0.300 | 1.5200 | 62 | 0.42 |
| 3 | ∞ | 0.065 | 1.5721 | 35 | 0.42 |
| 4* | 2.050 | 0.332 | | | 0.44 |
| 5* | −3.076 | 0.086 | 1.5139 | 57 | 0.45 |
| 6 | ∞ | 0.970 | 1.5200 | 62 | 0.54 |
| 7 | ∞ | 0.431 | 1.5721 | 35 | 0.69 |
| 8* | 9.515 | 0.050 | | | 1.39 |
| 9 | ∞ | 0.100 | 1.5163 | 64 | 1.45 |
| 10 | ∞ | 0.050 | | | 1.62 |
| 11 | ∞ | 0.350 | 1.4714 | 65 | 1.64 |
| 12 | ∞ | | | | 1.66 |

ASPHERIC SURFACE COEFFICIENT

| | |
|---|---|
| 1st SURFACE | K = −4.769E−01 |
| | A4 = 3.130E−02 |
| | A6 = 2.562E+00 |
| | A8 = −2.192E+01 |
| | A10 = 1.112E+02 |
| | A12 = −2.784E+02 |
| | A14 = 2.861E+02 |
| 2nd SURFACE | K = 8.793E+00 |
| | A4 = 3.067E−01 |
| | A6 = −3.287E+00 |
| | A8 = 3.816E+01 |
| | A10 = −1.391E+02 |
| | A12 = 9.171E+01 |
| | A14 = 5.650E+02 |
| 3rd SURFACE | K = 1.061E+01 |
| | A4 = −9.453E−01 |
| | A6 = 2.676E+00 |
| | A8 = −5.473E+00 |
| | A10 = −2.488E+01 |
| | A12 = 7.905E+01 |
| | A14 = −1.241E+02 |
| | A16 = 1.178E+02 |
| 4th SURFACE | K = −3.482E+01 |
| | A4 = −6.511E−02 |
| | A6 = −8.901E−03 |
| | A8 = −2.101E−02 |
| | A10 = 1.666E−02 |
| | A12 = −4.294E−03 |
| | A14 = −1.416E−04 |
| | A16 = 1.255E−04 |

LENS GROUP DATA

| | | | FOCAL |
|---|---|---|---|
| LENS | START | END | DISTANCE |
| GROUP | SURFACE | SURFACE | (mm) |
| 1 | 1 | 4 | 2.10 |
| 2 | 5 | 8 | −4.22 |

In accordance with conditions shown in the following Table 2, post-curing was performed one time, two times, or three times at their respective predetermined temperatures (post-curing temperatures) for their respective predetermined periods of time (post-curing processing times), so that wafer lenses were produced. After that, each wafer lens was diced into pieces, so that image pickup lenses of “Samples 1 to 20” were produced.

### (2) Evaluation of Sample

In the example, a condition with which the back focus (fB) of an image pickup lens moves (changes) 10 μm by reflow is considered as having a problem for practical use. When a PV value, which indicates change in the surface shape, of the surface S1 changes 300 nm, fB changes −10 μm. When the refractive index nd of the surface S1 changes +80×E-5, fB changes −10 μm. Change in the surface shape (surface shape change) and change in the refractive index (refractive index change) of the surfaces S2, S3 and S4 do not influence fB much, so that the following evaluation was carried out on the basis of the surface shape change and the refractive index change of the surface S1.

### <Surface Shape Change>

The surface shape change of the surface S1 (16a) was measured by an Ultra Accuracy 3-D Profilometer UA3P (produced by Panasonic Cooperation) each time reflow was performed with respect to the image pickup lenses of “Samples 1 to 20”. Here, a difference between the largest error (Peak) from a design value of a mold in shape and the smallest error (Valley) therefrom is referred to as a PV value. The following evaluation was carried out by taking a PV value measured after molding (releasing) to second post-curing are performed (but before reflow is performed) as a reference. The result is shown in Table 2.

x (cross)
PV value changed 100 nm or more each time reflow was performed, and changed 300 nm or more in total when reflow was performed three times

Δ (triangle)
PV value changes 20 nm to less than 100 nm each time reflow was performed

◯ (circle)
PV value changed less than 20 nm each time reflow was performed

⊚ (double circle)
PV value changed less than 10 nm each time reflow was performed

### <Transmittance Before Reflow>

The total light transmittance of the transmittance before reflow was measured by a U-4100 UV-Visible-NIR Spectrophotometer (produced by Hitachi Ltd.) with respect to the obtained “Samples 1 to 20”. The total light transmittance is obtained by measuring a total transmitted light volume to an incident ray volume of visible rays of light in accordance with ASTM D-1003.

Then, the transmittance before reflow was evaluated at a relative value, taking the total light transmittance of a comparative example 1 as 100%. The result is shown in Table 2.

| | |
|---|---|
| ◯ (circle) | 90% or more |
| Δ (triangle) | 80% to less than 90% |
| X (cross) | less than 80% |

### <Resin Separation in Dicing>

Each of the obtained wafer lenses was diced by a dicer which performs cutting using an endless cutter (rotary cutter) with abrasive grain at a speed of 3 to 7 mm/sec. into pieces so that the image pickup lenses, the “Samples 1 to 20”, were obtained. In order to prevent frictional heat, the wafer lens was diced while being sprayed with pure water. The result is shown in Table 2.

Of the obtained image pickup lenses by dicing,

⊚ (double circle)
95% or more had no resin separation

◯ (circle)
90% to less than 95% had no resin separation

Δ (triangle)
70% to less than 90% had no resin separation

x (cross)
Less than 70% had no resin separation

For example, when 1000 image pickup lenses were obtained by dicing, and 950 or more image pickup lenses had no resin separation, “◯ (circle)” is shown in Table 2.

### <Refractive Index Change>

Parallel plates each having a thickness of 1 mm and made of the epoxy resin were produced in accordance with conditions for post-curing shown in Table 2 as the “Samples 1 to 20”.

Each time reflow was performed, the refractive index change was measured by a KPR-200 Precision Refractometer (produced by Shimadzu Cooperation) with respect to the “Samples 1 to 20”, which are the parallel plates. The result is shown in Table 2. The refractive index nd of d line measured after molding (releasing) but before reflow was taken as a reference.

x (cross)
Refractive index changed 30×E-5 or more each time reflow was performed, and changed 80×E-5 or more in total when reflow was performed three times

Δ (triangle)
Refractive index changed 5×E-5 to less than 30×E-5 each time reflow was performed

◯ (circle)
Refractive index changed less than 5×E-5 each time reflow was performed

TABLE 2-1

| | | | 1st | | 2nd | | 3rd |
|---|---|---|---|---|---|---|---|
| | | 1st | POST-CURING | 2nd | POST-CURING | 3rd | POST-CURING |
| | | POST-CURING | PROCESSING | POST-CURING | PROCESSING | POST-CURING | PROCESSING |
| SAMPLE | Tg | TEMPERATURE | TIME | TEMPERATURE | TIME | TEMPERATURE | TIME |
| 1 | 190 | 150 | 1 | — | — | — | — |
| 2 | 190 | 150 | 6 | — | — | — | — |
| 3 | 190 | 150 | 1 | 170 | 4 | — | — |
| 4 | 190 | 200 | 1 | — | — | — | — |
| 5 | 190 | 200 | 0.5 | 170 | 2 | — | — |
| 6 | 190 | 200 | 1 | 170 | 4 | — | — |
| 7 | 190 | 200 | 1 | 170 | 7 | — | — |
| 8 | 190 | 200 | 2 | 170 | 4 | — | — |
| 9 | 190 | 200 | 2 | 170 | 7 | — | — |
| 10 | 190 | 200 | 4 | — | — | — | — |
| 11 | 190 | 230 | 1 | — | — | — | — |
| 12 | 190 | 230 | 1 | 170 | 4 | — | — |
| 13 | 190 | 170 | 6 | — | — | — | — |
| 14 | 190 | 170 | 4 | 230 | 1 | — | — |
| 15 | 190 | 170 | 4 | 200 | 1 | — | — |
| 16 | 190 | 130 | 6 | 260 | 1 | — | — |
| 17 | 190 | 110 | 6 | 260 | 1 | — | — |
| 18 | 190 | 170 | 2 | 300 | 1 | — | — |
| 19 | 190 | 200 | 1 | 170 | 4 | 260 | 0.5 |
| 20 | 190 | 170 | 4 | 200 | 1 | 260 | 0.5 |

TABLE 2-2

| | | | | RESIN | |
|---|---|---|---|---|---|
| | REFRACTIVE | SURFACE | TRANSMITTANCE | SEPARATION | |
| SAMPLE | INDEX CHANGE | SHAPE CHANGE | BEFORE REFLOW | IN DICING | |
| 1 | X | X | ◯ | X | COMPARATIVE EXAMPLE |
| 2 | X | Δ | ◯ | Δ | COMPARATIVE EXAMPLE |
| 3 | Δ | Δ | ◯ | Δ | COMPARATIVE EXAMPLE |
| 4 | ◯ | X | ◯ | X | COMPARATIVE EXAMPLE |
| 5 | ◯ | Δ | ◯ | Δ | COMPARATIVE EXAMPLE |
| 6 | ◯ | ◯ | ◯ | ⊚ | EXAMPLE |
| 7 | ◯ | ◯ | X | ◯ | COMPARATIVE EXAMPLE |
| 8 | ◯ | ◯ | ◯ | ◯ | EXAMPLE |
| 9 | ◯ | ◯ | X | ◯ | COMPARATIVE EXAMPLE |
| 10 | ◯ | ◯ | X | ◯ | COMPARATIVE EXAMPLE |
| 11 | ◯ | X | ◯ | X | COMPARATIVE EXAMPLE |
| 12 | ◯ | ◯ | ◯ | ◯ | EXAMPLE |
| 13 | X | Δ | ◯ | Δ | COMPARATIVE EXAMPLE |
| 14 | ◯ | ◯ | ◯ | ◯ | EXAMPLE |
| 15 | ◯ | ◯ | ◯ | ◯ | EXAMPLE |
| 16 | ◯ | ⊚ | ◯ | ◯ | EXAMPLE |
| 17 | ◯ | Δ | Δ | ◯ | COMPARATIVE EXAMPLE |
| 18 | ◯ | Δ | X | Δ | COMPARATIVE EXAMPLE |
| 19 | ◯ | ⊚ | ◯ | ⊚ | EXAMPLE |
| 20 | ◯ | ⊚ | ◯ | ◯ | EXAMPLE |

### (3) Conclusion

According to the results shown in Table 2, Samples 6, 8, 12, 14, 15 and 16 on which first post-curing and second post-curing were performed under the conditions of the embodiment of the present invention was able to prevent the surface shape and the refractive index from changing even when reflow is performed multiple times after post-curing, and also prevent the light transmittance from decreasing, and the resins from separating from the glass substrate of the wafer lens, which occurs in dicing. In particular, Samples 14, 15 and 16 on which first post-curing was performed after second post-curing had better stability of the surface shape than that of Samples 6, 8 and 12 on which second post-curing was performed after first post-curing.

Moreover, Samples 19 and 20 on which third post-curing was performed had excellent stability of the surface shape.

Furthermore, the same evaluation was carried out with respect to other samples (not shown) made of an acrylic resin instead of the epoxy resin, the acrylic resin which has a glass transition temperature Tg comparable to that of the epoxy resin. The samples were able to obtain the same effects.

According to the examination by the present inventor et al., change in optical values of a lens portion by reflow includes: change in the optical properties caused by change in the refractive index of the curing resin during reflow; and change in the optical properties caused by change in the surface shape of the lens portion. According to the further examination by the present inventor et al., it is difficult to reduce the change in the optical properties caused by the change in the refractive index and the change in the optical properties caused by the change in the surface shape by performing post-curing at a fixed temperature. That is, if post-curing is performed at a relatively high temperature for a long time, resin changes its color, so that the post-curing cannot be performed for a sufficient time, and accordingly the change in the optical properties caused by the change in the surface shape during reflow remains. On the other hand, if post-curing is performed at a relatively low temperature for a long time, although resin does not change its color, the change in the optical properties caused by the change in the refractive index during reflow remains. Then, according to the embodiment of the present invention, first post-curing at a high temperature and second post-curing at a low temperature are performed. Accordingly, the resin does not change its color by being heated, and the change in the optical properties during reflow can be reduced. In addition, because the change in the optical properties during reflow is sufficiently reduced by first post-curing and second post-curing, it becomes unnecessary to perform optical design by taking the change in the optical properties caused by reflow into account. Also, because the optical properties are not influenced by the number of times that reflow is performed, there is no limit to producing an electronic device.

Accordingly, the present invention can prevent the surface shape of an image pickup lens and the refractive index thereof from changing, and can easily perform optical design in producing a wafer lens from which the image pickup lens is obtained, no matter how many times reflow is performed to install a camera module (image pickup module) using the image pickup lens in an electronic device. Furthermore, the present invention can prevent the light transmittance of an image pickup lens from decreasing, which is caused by reflow, and prevent resin from separating from a glass substrate of a wafer lens, which is caused in dicing the wafer lens.

According to a first aspect of the embodiment of the present invention, there is a wafer lens member producing method for producing a wafer lens member with a plurality of lens portions made of a light-curing resin formed on at least one face of a substrate, the method including: curing the light-curing resin filled between a mold having a molding face which forms the lens portions and the at least one face of the substrate; releasing the mold from the substrate; and post-curing the lens portions so as to promote the curing of the light-curing resin, the post-curing including: first post-curing which performs heating at a first post-curing temperature, which is a glass transition temperature of the light-curing resin to the glass transition temperature+100° C., for 30 minutes to two hours; and second post-curing which performs heating at a second post-curing temperature, which is lower than the glass transition temperature, and lower than the first post-curing temperature by 25° C. or more, for three hours to six hours.

Preferably, in the wafer lens member producing method, the first post-curing is performed after the second post-curing.

Preferably, in the wafer lens member producing method, the second post-curing is performed after the first post-curing.

Preferably, in the wafer lens member producing method, the post-curing further includes third post-curing which performs heating at a third post-curing temperature, which is the glass transition temperature to the glass transition temperature+100° C., for 15 minutes to one hour.

According to a second aspect of the embodiment of the present invention, there is provided an image pickup lens producing method including: dicing the wafer lens member produced by the wafer lens member producing method into pieces which respectively include the lens portions.

According to a third aspect of the embodiment of the present invention, there is provided an image pickup module producing method including: superposing the wafer lens member produced by the wafer lens member producing method on an image pickup element member on which a plurality of image pickup element portions is formed; and dicing the wafer lens member superposed on the image pickup element member into pieces which respectively include the lens portions, and which respectively include the image pickup element portions.

According to a fourth aspect of the embodiment of the present invention, there is provided an electronic device producing method including: performing reflow so as to mount the image pickup module produced by the image pickup module producing method on a circuit board.

What is claimed is:

1. A wafer lens member producing method for producing a wafer lens member with a plurality of lens portions made of a light-curing resin formed on at least one face of a substrate, the method comprising:
curing the light-curing resin filled between a mold having a molding face which forms the lens portions and the at least one face of the substrate;
releasing the mold from the substrate; and
post-curing the lens portions so as to promote the curing of the light-curing resin, the post-curing including:
first post-curing which performs heating at a first post-curing temperature, which is a glass transition temperature of the light-curing resin to the glass transition temperature+100° C., for 30 minutes to two hours; and
second post-curing which performs heating at a second post-curing temperature, which is lower than the glass transition temperature, and lower than the first post-curing temperature by 25° C. or more, for three hours to six hours.

2. The wafer lens member producing method according to claim 1, wherein the first post-curing is performed after the second post-curing.

3. The wafer lens member producing method according to claim 1, wherein the second post-curing is performed after the first post-curing.

4. The wafer lens member producing method according to claim 1, wherein the post-curing further includes third post-curing which performs heating at a third post-curing temperature, which is the glass transition temperature to the glass transition temperature+100° C., for 15 minutes to one hour.

5. An image pickup lens producing method comprising:
dicing the wafer lens member produced by the wafer lens member producing method according to claim 1 into pieces which respectively include the lens portions.

6. An image pickup module producing method comprising:
superposing the wafer lens member produced by the wafer lens member producing method according to claim 1 on an image pickup element member on which a plurality of image pickup element portions is formed; and
dicing the wafer lens member superposed on the image pickup element member into pieces which respectively include the lens portions, and which respectively include the image pickup element portions.

7. An electronic device producing method comprising:
performing reflow so as to mount the image pickup module produced by the image pickup module producing method according to claim 6 on a circuit board.
